(19) United States
(12) Patent Application Publication
(10) Pub. No.: US 2006/0262085 A1
(43) Pub. Date: Nov. 23, 2006

(54) Coupling apparatus for assembling and disassembling articles

(75) Inventor: Jung-Shan Yang, YungHo City (TW)

Correspondence Address: NIKOLAI & MERSEREAU, P.A., 900 SECOND AVENUE SOUTH, SUITE 820, MINNEAPOLIS, MN, 55402, US

(73) Assignee: Proview Electronics Co., Ltd., YungHo City (TW)

(21) Appl. No.: 11/131,490

(22) Filed: May 18, 2005

(51) Int. Cl. G09G 5/00

(52) U.S. Cl. 345/156; 361/681

(57) ABSTRACT

A coupling apparatus for assembling and disassembling articles adopted for use on an article (such as speaker) which includes at least one latch member and a movable coupling set and another article (such as a display screen) which has latch troughs corresponding to the latch member and the movable coupling set so that the first article and the second article can be assembled or disassembled rapidly and easily. The movable coupling set and the latch troughs also have terminals to form electric connection between the two articles.

### FIELD OF THE INVENTION

The present invention relates to a coupling apparatus for assembling and disassembling articles and particularly to a coupling apparatus to assemble or disassemble a speaker and a display device to facilitate rapid assembly or disassembly without affecting total assembled appearance.

### BACKGROUND OF THE INVENTION

Display devices (especially LCD TV, PDP TV, monitors and the like) that are compact, no radiation, have high picture quality and increasingly less expensive, have gradually replaced the conventional CRT display devices. With the digital TV channels now available, the PDP or large size LCD TVs that support digital signals, whether built-in or having an external TV set-top box, all are equipped with a computer or teleconference connector, and can receive multiple input signals. Application scope is enlarged. They are gradually accepted by consumers, and are likely to become the main stream of the display devices in the future.

At present, most display devices on the market are equipped with a speaker. Coupling of the speaker and the display device generally can be classified in three types:

1. The speaker and the display device are jointly housed in a case.

2. The speaker is fastened to two sides of the display device through screws, coupling plates or other fastening means.

3. The speaker and the display device are separated and independent devices.

The first type simplifies wiring of sound sources and is tidier, but cannot provide surround sound effect.

The second type can have the speaker installed outside the display device through the screws and coupling plates to achieve improved the surround effect. But the speaker is an independent element. Whether the speaker is disassembled or connected externally, the external audio and display device wiring is untidy. Moreover, unless the speaker and the display device are designed together, and a speaker pedestal is provided by the manufacturer, the disassembled speaker cannot be installed in a matched manner. The appealing of total configuration suffers.

In the third type, the speaker has its own pedestal. The distance between the speaker and the display device can be adjusted as desired to achieve the optimum surround effect. But whether the speaker is installed adjacent to two sides of the display device or remote from the display device, extra sound source wiring is required.

All the three types of speaker installation, whether the audio effect is desirable or not, have common problems. Namely the speaker and the display device either have to be coupled closely or the speaker has to be mounted on two sides, and an extra wring is required that is often untidy.

### SUMMARY OF THE INVENTION

Therefore the primary object of the invention is to provide a coupling apparatus for assembling and disassembling articles and particularly to a coupling apparatus to assemble or disassemble a speaker and a display device quickly.

Another object of the invention is to provide a coupling apparatus to assemble articles without affecting the overall appearance and maintain the exterior features of the articles.

The coupling apparatus for assembling and disassembling articles according to the invention includes at least one latch member which has a body and a head larger than the body, the body having one end fastened to a first article (such as a speaker); a movable coupling set which includes a movable coupling member and a urging member, the movable coupling member being able to run through an aperture formed on the first article and having one end coupled with the urging member to be slidable in the aperture; at least one first latch trough formed on a second article (such as a display device) corresponding to the first article and having an insertion zone and a coupling zone, the head of the latch member being smaller than the insertion zone but larger than the coupling zone, the body of the latch member being smaller than the coupling zone, and the latch member being engageable with the first latch trough; and a second latch trough formed on the second article corresponding to the movable coupling member of the first article. The movable coupling member has another end insertable into the second latch trough.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of the invention;

FIG. 2 is a schematic view of a speaker and a display device during a coupling condition according to the invention; and

FIG. 3 is a schematic view of a speaker and a display device in a coupled condition according to the invention.

### DESCRIPTION OF THE PREFERRED EMBODIMENT

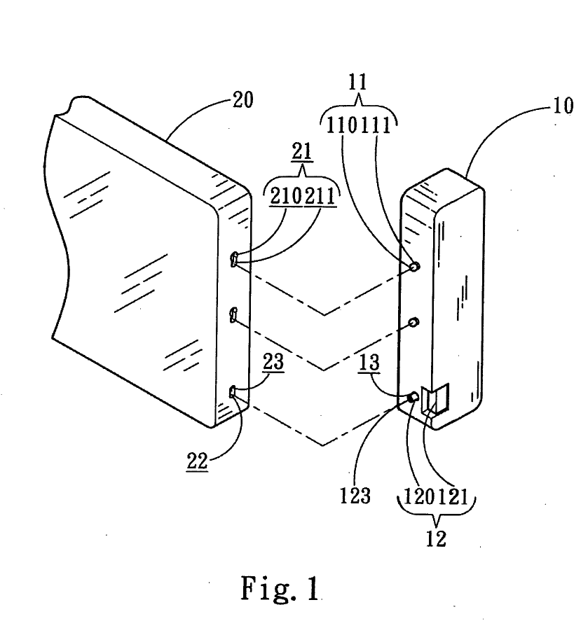

Referring to FIG. 1 for an exploded view of the invention. The invention mainly includes a first article and a second article. In an embodiment of the invention, the first article is a speaker 10, and the second article is a display device 20. The speaker 10 has two latch members 11 and a movable coupling set 12. The display device 20 has two first latch troughs 21 engageable with the latch members 11 and a second latch trough 22 engageable with the movable coupling set 12. The latch member 11 has a body 111 and a head 110. The head 110 is larger than the body 111. The body 111 has one end fastened to the speaker 10. The movable coupling set 12 includes a movable coupling member 120 and a urging member 121. The movable coupling member 120 can run through an aperture 13 formed on the speaker 10. The movable coupling member 120 further has one end coupled (not shown in the drawings) on the urging member 121 and is slidable in the aperture 13. The first latch trough 21 has an insertion zone 210 and a coupling zone 211. The head 110 of the latch member 11 is smaller than the insertion zone 210 but is larger than the coupling zone 211. The body 111 of the latch member 11 is smaller than the coupling zone 211. Hence the latch member 11 may be latched in the first latch trough 21. The second latch trough 22 can receive another end of the movable coupling member 120.

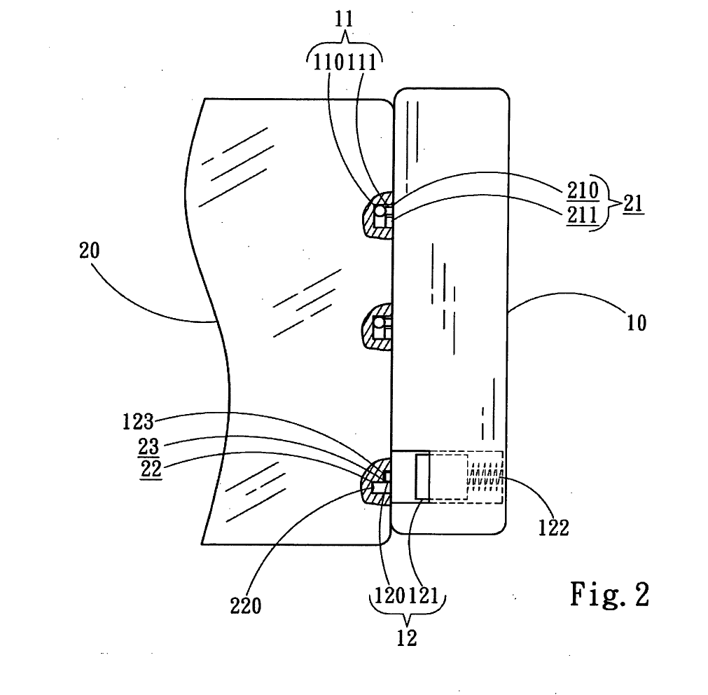

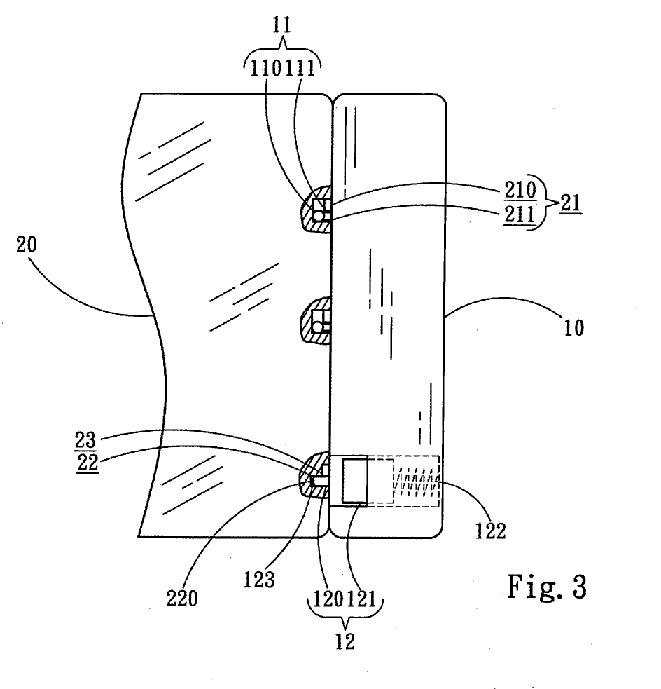

Refer to FIGS. 2 and 3 for coupling the speaker 10 with the display device 20. First, move the urging member 121 to push the movable coupling member 120 through the aperture 13 towards the speaker 10 to insert the head 110 of the latch member 11 into the insertion zone 210 of the first latch trough 21; next, move the speaker 10 downwards relative to the display device 20 so that the body 111 of the latch member 11 reaches the coupling zone 211 of the first latch trough 21; move the urging member 121 back to its original position, or through a returning device 122 (such as a spring) which is provided in advance to couple with the urging member 121, so that the urging member 121 can return to its original position through the returning device 122 and drive the movable coupling member 120 into the second latch trough 22; as the head 11O of the latch member 11 is larger than the insertion zone 211 of the first latch trough 21, a latch condition is formed.

Since it could happen that the movable coupling member 120 does not fully retract into the speaker 10, the second latch trough 22 has a latch trench 23 on one side at a depth smaller than the second latch trough 22 to overcome this problem. The latch trench 23 also can facilitate anchoring to make using easier. Moreover, the movable coupling member 120 may have a first terminal 123 on one end which is coupled with the second latch trough 22. The second latch trough 22 may have a second terminal 220 corresponding to the first terminal 123 to enable the speaker 10 and the display device 20 to form an electric connection.

By means of the construction set forth above, assembly and disassembly of the speaker and display device can be accomplished rapidly and easily. The total appearance of the assembly is not affected. The exterior features of the article can also be maintained.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A coupling apparatus for assembling and disassembling articles, comprising:
at least one latch member which has a body and a head larger than the body, the body having one end fastened to a first article;
a movable coupling set which has a movable coupling member and a urging member, the movable coupling member being allowed to run through an aperture formed on the first article and having one end coupled with the urging member to slide in the aperture;
at least one first latch trough located on a second article corresponding to the latch member of the first article having an insertion zone and a coupling zone, the diameter of the head of the latch member being smaller than the insertion zone and larger than the coupling zone, the body being smaller than the coupling zone so that the latch member is latchable in the first latch trough; and
a second latch trough located on the second article corresponding to the movable coupling member to couple with another end of the movable coupling member;
wherein the another end of the movable coupling member has a first terminal, the second latch trough having a second terminal corresponding to the first terminal for the first article connected to the second article.

2. The coupling apparatus of claim 1, wherein the second latch trough has a latch trench abutting one side thereof and being formed at a depth smaller than the second latch trough to facilitate anchoring of the movable coupling member.

3. The coupling apparatus of claim 2, wherein the movable coupling set has a returning device.

4. The coupling apparatus of claim 3, wherein the returning device is a spring.

5. The coupling apparatus of claim 3, wherein the first article is a speaker or a display device.

6. The coupling apparatus of claim 5, wherein the second article is a display device or a speaker different from the first article.
